(19) United States
(12) Patent Application Publication
(10) Pub. No.: US 2013/0121300 A1
(43) Pub. Date: May 16, 2013

(54) METHOD FOR REENTERING NETWORK OF NO-MOBILITY MOBILE STATION IN IDLE STATE AND METHOD FOR SUPPORTING SAME

(71) Applicants: Heejeong Cho, Anyang-si (KR); Eunjong Lee, Anyang-si (KR); Youngsoo Yuk, Anyang-si (KR)

(72) Inventors: Heejeong Cho, Anyang-si (KR); Eunjong Lee, Anyang-si (KR); Youngsoo Yuk, Anyang-si (KR)

(73) Assignee: LG ELECTRONICS INC., Seoul (KR)

(21) Appl. No.: 13/811,637

(22) PCT Filed: Jul. 22, 2011
(86) PCT No.: PCT/KR11/05440

§ 371 Date: Jan. 22, 2013

Related U.S. Application Data
(60) Provisional application No. 61/366,534, filed on Jul. 22, 2010.

(30) Foreign Application Priority Data
Jul. 22, 2011 (KR) 10-2011-0072949

(51) Int. Cl. H04W 72/04

(52) U.S. Cl. CPC H04W 72/042
USPC 370/329

(57) ABSTRACT

Disclosed are a method for reentering the network of a no-mobility idle state mobile station and a method for supporting same. A device for supporting the reentry into the network of a no-mobility idle state mobile station in a wireless communication system of the present invention comprises a transmitter for transmitting to the no-mobility idle state mobile station a first information including information on whether an uplink region has been allocated just for the no-mobility idle state mobile station. The first information can further include information on the allocated uplink region. The mobile station for executing the reentry into the network of the present invention comprises a receiver for receiving from a base station a first information including information on whether an uplink area has been allocated just for the no-mobility idle state mobile station. The first information can further include information on the allocated uplink region.

### TECHNICAL FIELD

The present invention relates to a wireless communication, and more particularly, to a method of reentering a network of an idle state mobile station having no mobility, a method of supporting the same and apparatus therefor.

### BACKGROUND ART

Broadband wireless communication system is based on an orthogonal frequency division multiplexing (OFDM) scheme, an orthogonal frequency division multiple access (OFDMA) scheme or an orthogonal frequency division multiple access (OFDMA) scheme and enables fast data transmission in a manner of transmitting a physical channel signal using multiple subcarriers.

A downlink data type transmitted to a mobile station by a base station is mainly classified into a multicasting/broadcasting data type and a unicast data type. The multicasting/broadcasting data type can be used by the base station in transmitting such information as system information, configuration information, software upgrade information and the like to at least one or more group(s) to which non-specific/specific mobile stations belong. And, the unicast data type can be used by the base station in transmitting a request information to a specific mobile station or sending a message containing information, (e.g., configuration information) which should be delivered to a specific mobile station only.

Meanwhile, an uplink data type transmitted to a base station, a different mobile station or the like by a mobile station consists of a unicast data type. The mobile station is able to send a message containing information, which will be finally delivered to a different mobile station, a server or the like, to the base station.

A conventional communication was mainly a communication performed between a mobile station used by a user and a base station. Yet, the development of communication technologies has enabled a machine-to-machine communication. The machine-to-machine (hereinafter abbreviated M2M) communication literally means a communication between one electronic device and another electronic device. In a broad sense, the M2M communication may mean a wire/wireless communication between electronic devices or a communication between a human-controllable device and a machine. Recently, the M2M communication may generally indicate a communication between electronic devices, i.e., a device-to-device wireless communication.

In the early 1990's, in which the concept of the M2M communication has been initially introduced, the M2M communication has been recognized as remote control or telematics and derivative markets of the M2M communication were very limitative. Yet, the M2M communication has grown rapidly for past few years and has been introduced into the globally noteworthy markets as well as Korean market. Specifically, in POS (point of sales) and security related application markets, the M2M communication has considerable influence on such field as fleet management, remote monitoring of machinery and equipment, smart meter for auto-measurement of operating time, consumed heat or electricity quantity on construction machinery equipment and the like. M2M communication in the future will be further utilized for various usages in connection with small-scale output communication solutions for conventional mobile communication, wireless high-speed internet, Wi-Fi, ZigBee and the like and may lay the foundation of expansion to B2C (business to consumer) markets instead of being confined to B2B (business to business) markets.

In the era of the M2M communication, every machine equipped with SIM card enables data transmission and reception and is capable of remote management and control. For instance, as M2M communication technology is usable for numerous devices and equipments including vehicles, trucks, containers, auto-vending machines, gas tanks and the like, its application fields may reach far and wide.

The M2M device makes a long-term report to a base station or makes a report to a base station in a manner of being event triggered. In particular, while staying most of time in an idle state, the M2M device wakes up and then enters an active state when a long-term cycle is back or an event is triggered. Moreover, although there are some M2M devices having mobility in a manner of being mounted on a moving object, most of the M2M devices may have low mobility or no mobility. Therefore, it may become necessary for a base station to identify the mobile stations staying in idle state without mobility only.

Moreover, since each idle-state mobile station without mobility needs to perform a network reentry procedure in the course of entering an active state, a method for an idle state mobile station without mobility to enter a network quickly and efficiently and a method for supporting the same have not been proposed in detail yet.

### DISCLOSURE OF THE INVENTION

### Technical Task

A technical task intended to achieve in the present invention is to provide a method for a base station to support a network reentry of an idle state mobile station having no mobility in a wireless communication system.

Another technical task intended to achieve in the present invention is to provide a method for an idle state mobile station having no mobility to perform a network reentry in a wireless communication system.

Another technical task intended to achieve in the present invention is to provide a base station apparatus for supporting a network reentry of an idle state mobile station having no mobility.

A further technical task intended to achieve in the present invention is to provide an idle state mobile station having no mobility, by which a network reentry can be performed.

Technical tasks obtainable from the present invention are non-limited the above mentioned technical tasks. And, other unmentioned technical tasks can be clearly understood from the following description by those having ordinary skill in the technical field to which the present invention pertains.

### Technical Solution

To achieve the technical task and in accordance with the present invention, as embodied and broadly described, a method of supporting a network reentry of an idle state mobile station having no mobility by a base station in a wireless communication system includes the step of transmitting first information including an information indicating whether there is an assigned uplink region only for the idle state mobile station having no mobility to the idle state mobile station having no mobility. The method further includes the step of transmitting second information including information on the assigned uplink region to the idle state mobile station having no mobility, wherein the first information is at least a superframe header (SFH), a broadcast control channel (BCCH), a non-user specific A-MAP IE, an extended non-user specific A-MAP IE, or a physical downlink control channel (PDCCH). Preferably, the information on the assigned uplink region is indicated by a superframe index, a frame index, a subframe index, or a slot index.

Preferably, the first information further includes the information on the assigned uplink region. The information on the assigned uplink region is transmitted in a manner of being masked with an identifier for the idle state mobile station having no mobility. The first information is a user specific A-MAP IE, an extended user specific A-MAP IE, or a physical downlink control channel (PDCCH).

The method of supporting a network reentry of an idle state mobile station having no mobility by a base station further includes the step of receiving a ranging request message from the idle state mobile station having no mobility via the assigned uplink region. And, the method includes the steps of transmitting third information including a downlink identifier indicating whether there is an assigned downlink region for the idle state mobile station having no mobility and transmitting fourth information including the information on the downlink region masked with the identifier for the idle state mobile station having no mobility. The method further includes the step of sending a ranging response message in response to the ranging request message.

To achieve the another technical task and in accordance with the purpose of the present invention, as embodied and broadly described, a method of performing a network reentry of an idle state mobile station having no mobility in a wireless communication system includes the step of receiving first information including information indicating whether there is an assigned uplink region only for the idle state mobile station having no mobility from a base station. And, the method further includes the step of receiving second information including the information on the assigned uplink region from the base station, wherein the first information is at least a superframe header (SFH), a broadcast control channel (BCCH), a non-user specific A-MAP TIE, an extended non-user specific A-MAP IE, or a physical downlink control channel (PDCCH).

Preferably, the first information further includes the information on the assigned uplink region. The information on the assigned uplink region is transmitted in a manner of being masked with an identifier for the idle state mobile station having no mobility.

The method of performing a network reentry of an idle state mobile station having no mobility further includes the step of sending a ranging request message to the base station via the assigned uplink region. And, the method further includes the steps of receiving third information including a downlink identifier indicating whether there is an assigned downlink region for the mobile station having no mobility in idle state from the base station, receiving fourth information including the information on the downlink region masked with the identifier for the idle state mobile station having no mobility from the base station and receiving a ranging response message from the base station.

To achieve the another technical task and in accordance with the purpose of the present invention, a base station apparatus, which supports a network reentry of an idle state mobile station having no mobility includes a transmitter configured to transmit first information including information indicating whether there is an assigned uplink region only for the idle state mobile station having no mobility to the idle state mobile station having no mobility. Preferably, the first information further includes the information on the assigned uplink region.

To achieve the further technical task and in accordance with the purpose of the present invention, a mobile station apparatus performing a network reentry in a wireless communication system includes a receiver configured to receive first information including an information indicating whether there is an assigned uplink region only for the idle state mobile station having no mobility from a base station. Preferably, the first information further includes the information on the assigned uplink region and the information on the assigned uplink region is transmitted in a manner of being masked with an identifier for the idle state mobile station having no mobility.

### Advantageous Effects

According to various embodiments of the present invention, each idle state mobile station having no mobility performs a fast and efficient network reentry, whereby communication performance is considerably enhanced.

An idle state mobile station having no mobility is able to receive downlink data for the corresponding idle state mobile station having no mobility and other mobile stations except the idle state mobile stations having no mobility are able to receive downlink data for them, whereby communication performance is considerably enhanced.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram for configurations of a base station 105 and a mobile station 110 in a wireless communication system 100.

FIG. 2 is a diagram for one example of a process for transmitting downlink data to a base station and an idle state mobile station in IEEE 802.16 system.

FIG. 3 is a diagram to describe a method for an idle state mobile station having no mobility to perform a network reentry procedure in IEEE 802.16m system according to one embodiment of the present invention.

FIG. 4 is a diagram to describe a method for an idle state mobile station having no mobility to perform a network reentry procedure in IEEE 802.16m system according to another embodiment of the present invention.

FIG. 5 is a diagram to describe a method for an idle state mobile station having no mobility to perform a network reentry procedure in IEEE 802.16m system according to another embodiment of the present invention.

FIG. 6 is a flowchart to describe an operation of an idle state mobile station having no mobility according to one embodiment of the present invention described in FIG. 4.

FIG. 7 is a diagram to describe an operation of a mobile station (or the rest of mobile stations) other than an idle state mobile station having no mobility in IEEE 802.16m system according to one embodiment of the present invention described with reference to FIG. 4.

FIG. 8A and FIG. 8B are flowcharts to describe an operation of an idle state mobile station having no mobility according to one embodiment of the present invention.

FIG. 9 is a diagram to describe an operation in aspect of a mobile station other than an idle state mobile station having no mobility according to another embodiment of the present invention.

### BEST MODE

### Mode for Invention

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes IEEE (institute of electrical and electronics engineers) 802.16 system or 3GPP (3^{rd} generation partnership project) system, they are applicable to other random mobile communication systems except unique features of IEEE 802.16 system or 3GPP system.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS), and the like. And, assume that a base station is a common name of such a random node of a network stage communicating with a terminal as a Node B, an eNode B, a base station (BS), an access point (AP) and the like.

In a mobile communication system, a mobile station may be able to receive information in downlink from a base station and transmit information in uplink to the base station. The informations transmitted or received by the mobile station may include data and various control informations. And, various kinds of physical channels may exist in accordance with types and usages of the informations transmitted or received by the mobile station.

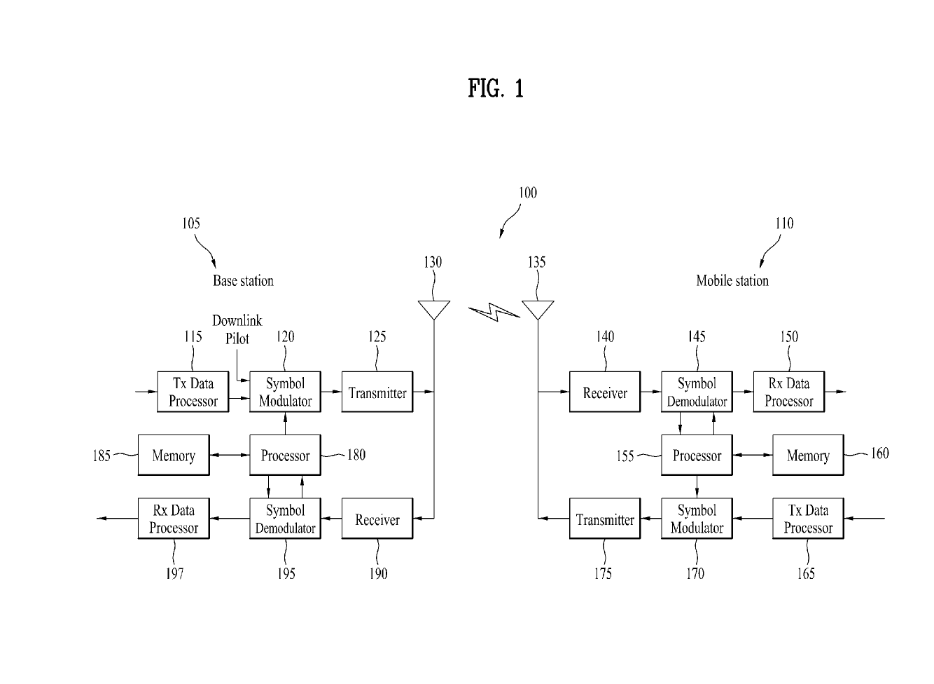

FIG. 1 is a block diagram for configurations of a base station 105 and a mobile station 110 in a wireless communication system 100.

Although one base station 105 and one mobile station 110 are shown in the drawing to schematically represent a wireless communication system 100, the wireless communication system 100 may include at least one base station and/or at least one mobile station.

Referring to FIG. 1, a base station 105 may include a transmitted (Tx) data processor 115, a symbol modulator 120, a transmitter 125, a transceiving antenna 130, a processor 180, a memory 185, a receiver 190, a symbol demodulator 195 and a received data processor 197. And, a mobile station 110 may include a transmitted (Tx) data processor 165, a symbol modulator 175, a transmitter 175, a transceiving antenna 135, a processor 155, a memory 160, a receiver 140, a symbol demodulator 155 and a received data processor 150. Although the base station/mobile station 105/110 includes one antenna 130/135 shown in the drawing, each of the base station 105 and the mobile station 110 includes a plurality of antennas. Therefore, each of the base station 105 and the mobile station 110 according to the present invention supports an MIMO (multiple input multiple output) system. And, the base station 105 according to the present invention may support both SU-MIMO (single user-MIMO) and MU-MIMO (multi user-MIMO) systems.

In downlink, the transmitted data processor 115 receives traffic data, performs coding on the received traffic data by formatting, interleaves the coded traffic data, modulates (or symbol maps) the interleaved data, and then provides modulated symbols (data symbols). The symbol modulator 120 provides a stream of symbols by receiving and processing the data symbols and pilot symbols.

The symbol modulator 120 multiplexes the data and pilot symbols together and then transmits the multiplexed symbols to the transmitter 125. In doing so, each of the transmitted symbols may include the data symbol, the pilot symbol or a signal value of zero (i.e., null). In each symbol duration, pilot symbols may be contiguously transmitted. In doing so, the pilot symbols may include symbols of frequency division multiplexing (FDM), orthogonal frequency division multiplexing (OFDM), time division multiplexing (TDM), or code division multiplexing (CDM).

The transmitter 125 receives the stream of the symbols, converts the received stream to at least one or more analog signals, additionally adjusts the analog signals (e.g., amplification, filtering, frequency upconverting, etc.), and then generates a downlink signal suitable for a transmission on a radio channel. Subsequently, the downlink signal is transmitted to the mobile station via the transmitting antenna 130.

In the configuration of the mobile station 110, the receiving antenna 135 receives the downlink signal from the base station and then provides the received signal to the receiver 140. The receiver 140 adjusts the received signal (e.g., filtering, amplification and frequency downconverting), digitizes the adjusted signal, and then obtains samples. The symbol demodulator 145 demodulates the received pilot symbols and then provides them to the processor 155 for channel estimation.

The symbol demodulator 145 receives a frequency response estimated value for downlink from the processor 155, obtains data symbol estimated values (i.e., estimated values of the transmitted data symbols) by performing data modulation on the received data symbols, and then provides the data symbol estimated values to the received (Rx) data processor 150. The received data processor 150 reconstructs the transmitted traffic data by performing demodulation (i.e., symbol demapping, deinterleaving and decoding) on the data symbol estimated values.

The processing by the symbol demodulator 145 and the processing by the received data processor 150 are complementary to the processing by the symbol modulator 120 and the processing by the transmitted data processor 115 in the base station 105, respectively.

Regarding the mobile station 110 in uplink, the transmitted data processor 165 provides data symbols by processing the traffic data. The symbol modulator 170 provides a stream of symbols to the transmitter 175 by receiving the data symbols, multiplexing the received data symbols, and then performing modulation on the multiplexed symbols. The transmitter 175 generates an uplink signal by receiving the stream of the symbols and then, processing the received stream. The generated uplink signal is then transmitted to the base station 105 via the transmitting antenna 135.

In the base station 105, the uplink signal is received from the mobile station 110 via the receiving antenna 130. The receiver 190 obtains samples by processing the received uplink signal. Subsequently, the symbol demodulator 195 provides pilot symbols received in uplink and a data symbol estimated value by processing the obtained samples. The received data processor 197 reconstructs the traffic data transmitted from the mobile station 110 by processing the data symbol estimated value.

The processor 155/180 of the mobile station/base station 110/105 directs operations (e.g., control, adjustment, management, etc.) of the mobile station/base station 110/105. The processor 155/180 may be connected to the memory unit 160/185 configured to store program codes and data. The memory 160/185 is connected to the processor 155/180 to store operating systems, applications and general files.

The processor 155/180 may be called one of a controller, a microcontroller, a microprocessor, a microcomputer and the like. And, the processor 155/180 may be implemented using hardware, firmware, software and/or any combinations thereof. In the implementation by hardware, the processor 155/180 may be provided with one of ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 155/180 or saved in the memory 160/185 to be driven by the processor 155/180.

Layers of a radio protocol between a mobile station 110 and a base station 105 may be classified into 1^{st} layer L1 , 2^{nd} layer L2 and 3^{rd} layer L3 based on 3 lower layers of OSI (open system interconnection) model well known to communication systems. A physical layer belongs to the 1^{st} layer and provides an information transfer service via a physical channel. RRC (radio resource control) layer belongs to the 3^{rd} layer and provides control radio resources between UE and network. A mobile station and a base station may be able to exchange RRC messages with each other via a radio communication network using RRC layers.

The above-mentioned device performing M2M communications may be variously named one of an M2M device, an M2M communication device, an MTC (machine type communication) device and the like. And, a legacy mobile station may be named an HTC (human type communication) mobile station.

The number of M2M devices will increase gradually in a prescribed network in response to the increasing number of machine application types. The currently discussed machine application types may include (1) security, (2) public safety, (3) tracking and tracing, (4) payment, (5) healthcare, (6) remote maintenance and control, (7) metering, (8) consumer device, (9) POS (Point Of Sales) and fleet Management in security related market, (10) M2M communication of vending machine (11) smart meter for plant and machinery remote monitoring, operating time measurement on measurement on construction plant and machinery and auto-measurement of consumed heat or electricity quantity on construction plant and machinery, (12) surveillance video communication, and the like, by which the machine application types may be non-limited. And, there are ongoing discussions on other machine application types. As the number of machine application types increase, the number of M2M communication devices may increase rapidly compared to the number of general mobile communication devices.

As mentioned in the foregoing description, an M2M device may transmit a traffic to a base station on a long term basis or transmit data in case of event triggering. In particular, while maintaining most of time in idle state, the M2M device wakes up and then enters an active state when a long-term cycle is back or an event is triggered. And, most of M2M devices may have low mobility or no mobility. As the application types of M2M devices having no mobility are continuously increasing, numerous M2M devices of the application types will exist in a same base station. Therefore, in order to identify only the mobile stations staying in idle state without mobility, the base station may need an identifier of the idle-state mobile station without mobility.

Prior to explaining a method of transmitting/receiving data for a idle state mobile station having no mobility (or fixed idle stat mobile station), which is proposed by the present invention, identifiers used to identify legacy mobile stations in a wireless communication system shall be schematically explained as follows. In particular, a process for a base station to send PDCCH to a mobile station in downlink is explained using an example of 3GPP LTE system case.

First of all, a base station determines a PDCCH format in accordance with a DCI (downlink control information) which is to be sent to a mobile station and then attaches a CRC (cyclic redundancy check) to a control information. The CRC is masked with a unique identifier, which will be called a radio network temporary identifier (hereinafter abbreviated RNTI), in accordance with an owner or usage of PDCCH. Meanwhile, a terminology called a station identifier (STID) is used as a concept corresponding to an RNTI of 3GPP in IEEE 802.16m system.

If the PDCCH is provided for a specific mobile station, the CRC can be masked with a unique identifier of a mobile station, e.g., C-RNTI (cell-RNTI). If the PDCCH is provided for a paging message, the CRC can be masked with a paging indication identifier, e.g., P-RNTI (paging-RNTI). If the PDCCH is provided for a system information, the CRC can be masked with a system information identifier, e.g., SI-RNTI (system information-RNTI). In order to indicate a random access response which is the response to a transmission of a random access preamble of a mobile station, the CRC can be masked with RA-RNTI (random access-RNTI). Table 1 shows examples of an identifier that masks the PDCCH.

TABLE 1

| Type | Identifier | Description |
|---|---|---|
| UE-specific | C-RNTI | used for the UE corresponding to the |
| | | C-RNTI. |
| Common | P-RNTI | used for paging message. |
| | SI-RNTI | used for system information (It could be |
| | | differentiated according to the type of |
| | | system information). |
| | RA-RNTI | used for random access response (It could be |
| | | differentiated according to subframe or |
| | | PRACH slot index for UE PRACH |
| | | transmission). |
| | TPC-RNTI | used for uplink transmit power control |
| | | command (It could be differentiated |
| | | according to the index of UE TPC group). |

If C-RNTI is used, the PDCCH carries a control information for a corresponding specific mobile station. If a different RNTI is used, the PDCCH carries a shared control information received by all or a plurality of mobile stations within a cell. The base station generates a coded data by performing a channel coding on the CRC attached DCI. The base station then performs a rate matching according to the number of CCEs assigned to the PDCCH format. Subsequently, the base station generates modulated symbols by modulating the coded data. Thereafter, the base station maps the modulated symbols to the physical resource elements. Thus, the base station uses RNTI and STID as mobile station identifiers in LTE system and IEEE 802.16 system, respectively.

Prior to explaining a method of transmitting/receiving data in an idle state mobile station having no mobility according to the proposal made by the present invention, an idle state or an idle mode is explained as follows. First of all, an operation in idle state/mode may indicate the operation of enabling a downlink broadcast traffic transmission to be periodically performed despite that a mobile station is not registered to a specific base station on moving in a radio link environment consisting of multiple base stations in general. In case that the mobile station does not receive traffics from the base station for a predetermined time, the mobile station may be able to enter an idle state to save a power. The mobile station having entered the idle mode receives a broadcast message broadcasted by the base station in an average period (i.e., an available interval) and may be then able to determine whether to enter a normal mode or stay in the idle state. In particular, by performing a location update, the mobile station in the idle state may be able to inform a paging controller of its location.

An idle state may give a benefit to a mobile station by eliminating a handover-related activation request and general management requests. The idle state restricts the activity of the mobile station to a scanning in a discrete cycle, thereby saving a power and operating resources used by the mobile station. In particular, the idle state provides a simple and proper method capable of informing the mobile station of downlink traffics in pending and may give benefits to the mobile station and the base station by eliminating wireless interface and network handover (HO) traffics from an inactive mobile station.

Paging may indicate a function of acquiring a location (e.g., a prescribed base station, a prescribed switching center, etc.) of a mobile station in response to an occurrence of an incoming call in mobile communication. A plurality of base stations supportive of an idle state/mode may be able to configure a paging region in a manner of belonging to a specific paging group. In this case, the paging group indicates a logical group. The object of the paging group is to provide an adjacent range area pageable in downlink, if there exists a traffic that targets a mobile station. It is preferable to configure the paging group to satisfy the condition that the paging group is large enough for a specific mobile station to stay most of time within the same paging group but small enough for a paging load to maintain an appropriate level.

The paging group may be able to include at least one base station and one base station can be included in at least one or more paging groups. The paging group is defined by a management system. For the paging group, a paging group-action backbone network message can be used. In particular, a paging controller manages the list of idle state mobile stations using a paging-announce message corresponding to one of backbone network messages and may also manage an initial paging of every base station belonging to the paging group.

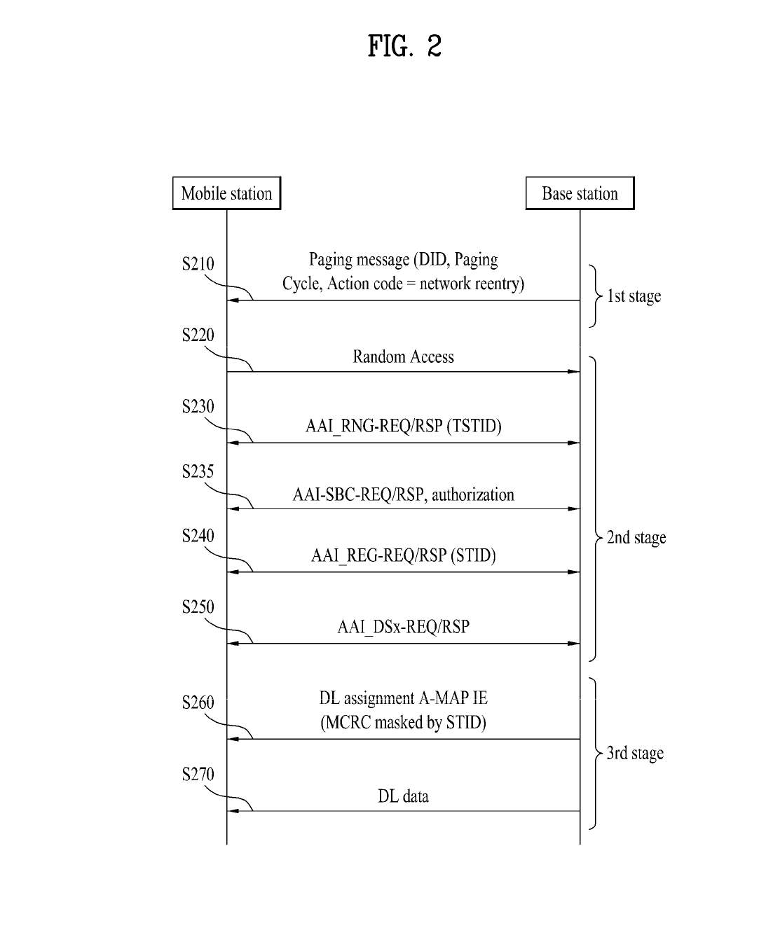

FIG. 2 is a diagram for one example of a process for an interaction after a network entry or reentry between a base station and an idle state mobile station in IEEE 802.16 system.

Referring to FIG. 2, since a base station does not know the exact locations of idle state mobile stations for transmitting/receiving data, every base station within a same paging group needs to send a paging message for requiring a network reentry to the corresponding mobile stations. Therefore, for the interaction with the idle state mobile station, each of the base stations within the same paging group to which the mobile station(s) belongs sends a paging message for requiring a network entry to the corresponding mobile station(s) in a listening interval of the corresponding mobile station(s) [S210].

If an information (e.g., deregistration ID (DID), paging cycle, etc.) of the idle state mobile station is included in the paging message, the corresponding mobile station needs to perform a procedure to enter an active state [S220]. In particular, each of the idle state mobile stations may be able to perform such a network entry procedure as a random access and the like [S220]. For instance, in IEEE 802.16 system, the idle state mobile station may be able to perform such a network reentry procedure as a ranging, a basic performance negotiation, a registration and the like. Meanwhile, an idle state mobile station in LTE system may be able to perform an RRC connection (re)establishment procedure. In this case, the base station assigns a TSTID, an STID, and an MTC group ID to the mobile station in idle state, which is attempting the network reentry, in IEEE 802.16 system. Yet, in 3GPP LTE/LTE-A system, the base station may assign an RNTI and an MTC group ID to an idle-state mobile station attempting the network reentry.

In particular, the idle state mobile station sends a ranging request message (e.g., AAI-RNG-REQ) to the base station and the base station may be then able to send a ranging response message (e.g., AAI-RNG-RSP) containing a temporary STID (TSTID), which is a temporary station identifier, to the idle state mobile station in response to the ranging request message [S230].

The idle state mobile station exchanges an SBC-REQ/RSP message with the base station and may be able to perform an authorization procedure together with the base station [S235].

The idle state mobile station sends a registration request message (e.g., AAI-REG-REQ) to the base station. In response to the registration request message, the base station assigns an STID to the idle state mobile station and may be then able to send a registration response message (e.g., AAI-REQ-RSP) to the corresponding mobile station in a manner that the assigned STID is contained in the registration response message [S240].

Thereafter, the idle state mobile station and the base station may be able to exchange dynamic service related messages with each other [S250]. The idle state mobile station may be then able to transmit/receive uplink/downlink data to/from the base station [S260].

Regarding FIG. 2, since the base station does not know the exact locations of the idle state mobile stations, every base station within a same paging group should send a paging message, one by one. In doing so, since the paging message should be sent in a manner of containing parameters (e.g., deregistration ID, DID, paging cycle and a required operation (action code) in IEEE 802.16m system) per each paged mobile station, it causes a problem that a downlink overhead may be generated.

Moreover, having received the paging message from the base station, the idle state mobile station performs a random access. In doing so, each of a plurality of idle state mobile stations attempts the random access, whereby uplink interference occurs. And, it causes a problem that probability of occurrence of collision between the mobile stations having attempted the random accesses may increase.

Since the base station should assign an ID used for the purpose of identifying a mobile station in active state to the corresponding mobile station, a lot of unique IDs are necessary.

Yet, in case of the idle state mobile station, since the mobile station does not move away into a different base station, it is not necessary for the base station to know the exact location of the idle state mobile station. Hence, the base station does not need to send a paging message to the idle state mobile station. Since the base station is aware of the location of the idle state mobile station, the mobile station having no mobility can be configured not to perform a random access process unnecessary to reenter a network.

To this end, it may be necessary for the base station to enable the mobile station to perform a network reentry procedure by unicast. In doing so, in order to minimize impact on a legacy mobile station (human type communication (HTC)), the base station may be able use an ID for the idle state mobile station, which is different from that (e.g., CID in IEEE 802.16e system, STID in IEEE 802.16m system and RNTI in 3GPP LTE system) for the HTC mobile station. In case of using a new ID, every mobile station should be able to recognize that an assignment information transmitted by the base station is provided for which mobile station. In particular, in case that a general mobile station and an idle state mobile station having no mobility coexist in a manner of having a same ID value, each of the mobile stations should be able to recognize whether the assignment information masked with the same value is the information of its own.

In case that an uplink resource is allocated to a prescribed mobile station, a processor 155 of the corresponding mobile station may be able to perform a procedure for a network reentry, i.e., sending a ranging request message in IEEE 802.16m system or sending an RRC connection establishment message in 3GPP.

When a base station needs to transmit/receive data to/from idle state mobile stations having no mobility, the base station needs to signal to general mobile stations as well as to the MTC mobile stations in various ways in order to indicate that a specific uplink resource region is used only for the idle state mobile stations having no mobility.

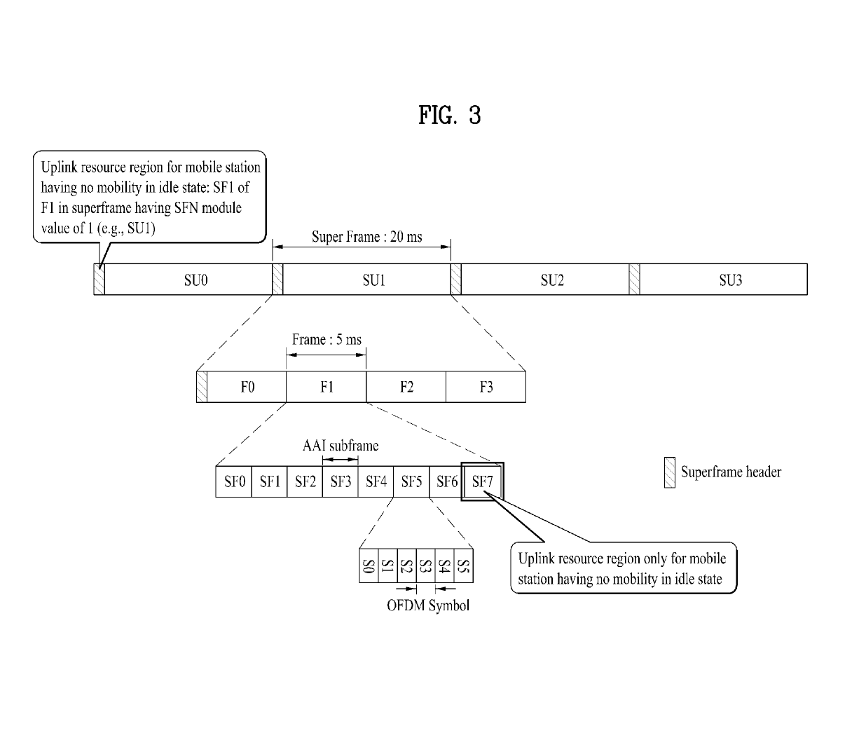

FIG. 3 is a diagram to describe a method for an idle state mobile station having no mobility to perform a network reentry procedure in IEEE 802.16m system according to one embodiment of the present invention.

Referring to FIG. 3, a base station may be able to inform all mobile stations of whether there is an uplink region assigned only for the idle state mobile stations having no mobility via channels for delivering system information (e.g., a downlink channel descriptor (DCD) in IEEE 802.16e system, a superframe header (SFH) in IEEE 802.16m system and a broadcast control channel (BCCH) in 3GPP). Moreover, the base station may be able to selectively inform the idle state mobile stations having no mobility of the information on the uplink region assigned for the idle state mobile stations having no mobility via the channels for delivering the system information.

The uplink region assigned to the idle state mobile stations having no mobility can be indicated by such an index value as a superframe index value, a frame index value, a subframe index value, a slot index value and the like. Depending on the indicated resource unit, the region assigned to the idle state mobile station having no mobility may be the one selected from the group consisting of a superframe, a frame, a subframe and a slot. Meanwhile, the uplink region assigned to the idle state mobile stations having no mobility can be assigned in a manner of being defined in advance (e.g., a specific frame in a specific superframe). Therefore, in this case, the base station needs not separately signal the information on the uplink region assigned to the idle state mobile stations having no mobility.

As shown in FIG. 3, the base station may be able to transmit the information on the uplink region assigned to the idle state mobile stations having no mobility via a superframe header in a superframe (SU0) having an index 0. For instance, the uplink region assigned to the idle state mobile stations having no mobility may be a subframe having an index 7 (SF7) of the frame having a frame index 1 (F1) of the superframe (SU1). A processor 155 of the idle state mobile station having no mobility may be able to obtain the assigned uplink region information in a manner of decoding the superframe header in the superframe having the index 0 (SU0). And, the idle state mobile station having no mobility may transmit uplink data to the base station via the subframe having the index 7 (SF7) of the frame (F1) having the index 1 in the superframe (SU1) having the index 1, which is the indicated uplink region.

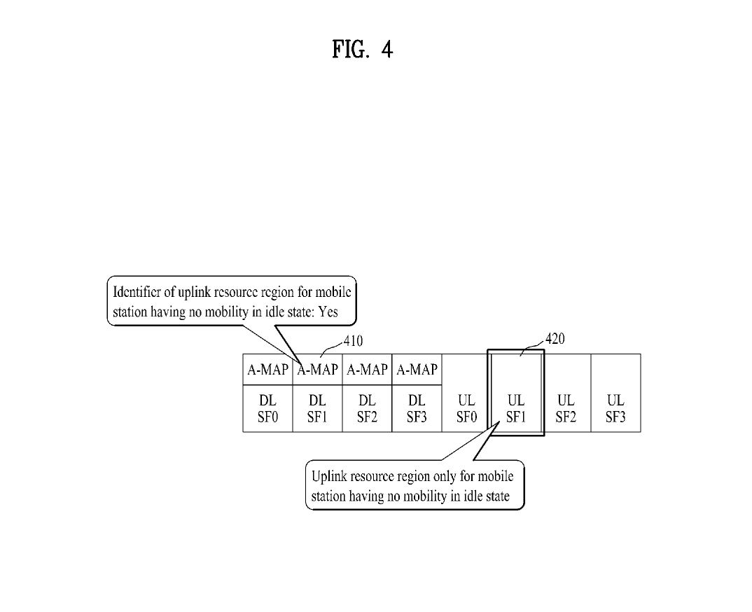

FIG. 4 is a diagram to describe a method for an idle state mobile station having no mobility to perform a network reentry procedure in IEEE 802.16m system according to another embodiment of the present invention.

Referring to FIG. 4, a base station may be able to inform all mobile stations of information on whether there is an uplink region (420) assigned only for the idle state mobile stations having no mobility via channels for delivering common assignment information (e.g., a DL-MAP in IEEE 802.16e system, a non-user specific A-MAP/extended non-user specific A-MAP in IEEE 802.16m system, and a physical downlink control channel (PDCCH) in 3GPP).

The base station may be able to inform the mobile stations (e.g., the idle state mobile station having no mobility) of the information on the uplink region (420) assigned to the idle state mobile stations having no mobility via the channels for delivering the common assignment information and the like. In particular, if the uplink region assigned for the idle state mobile station having no mobility is indicated by the channels for delivering the common assignment information, the uplink region assigned for the idle state mobile station having no mobility may be an uplink region (e.g., a subframe to which the non-user specific A-MAP is transmitted and a slot to which the PDCCH is transmitted) corresponding to the (extended) non-user specific A-MAP (410) and PDCCH via the (extended) non-user specific A-MAP, the PDCCH and the like.

Additionally, the base station may be able to inform the idle state mobile stations having no mobility of the information on the uplink region (e.g., all or a part of the uplink region 420), which is practically assigned to each of the idle state mobile stations having no mobility, via a separate user-specific A-MAP or PDCCH. In particular, the base station may indicate that which subframe or slot is corresponding to the uplink region assigned to the idle state mobile stations having no mobility via the channel for delivering the common assignment information and may be able to indicate that which region in the corresponding subframe/slot is corresponding to the region assigned to each of the idle state mobile stations via the user-specific A-MAP or the PDCCH. Each user-specific A-MAP IE/PDCCH transmitted in the same subframe/slot may be able to assign different regions in the corresponding subframe/slot to different mobile stations, respectively.

The uplink region (420) having assigned to a idle state mobile station without mobility by a base station may be a frame unit in IEEE 802.16e system, a subframe unit in IEEE 802.16m system, or a slot unit in 3GPP.

In case that a base station transmits information on uplink assignment region for an idle state mobile station having no mobility via PDCCH in 3GPP system, one of current RNTI reserved values (FFF4 to FFFD) can be used as an RNTI for transmitting the information on whether there is a corresponding uplink assignment. Preferably, the information on whether there is a corresponding uplink assignment may be situated in the fore of the PDCCH. Yet, in case that there exists control information on a BCCH and a PCH, the information on whether there is a corresponding uplink assignment may be situated after the control information.

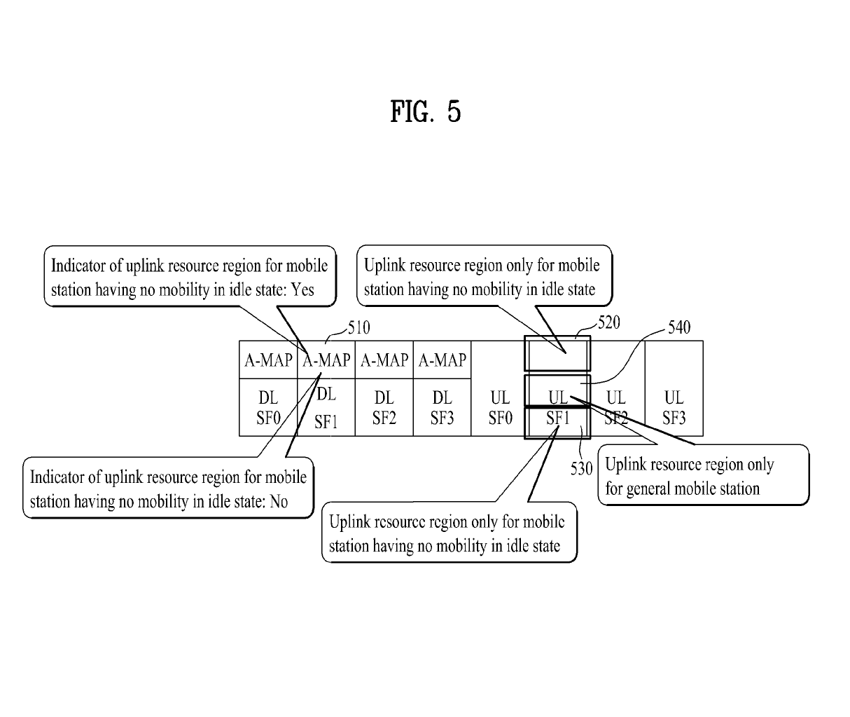

FIG. 5 is a diagram to describe a method for an idle state mobile station having no mobility to perform a network reentry procedure in IEEE 802.16m system according to another embodiment of the present invention.

Referring to FIG. 5, a base station may be able to add a field indicating whether an uplink region is assigned to an idle state mobile station having no mobility to a channel (e.g., a DL-MAP in IEEE 802.16e system, a user-specific A-MAP 510 in IEEE 802.16m system, a physical downlink control channel (PDCCH) in 3GPP, etc.) for practically delivering an assignment information of the mobile station. In particular, the base station enables the CRC of the channel for delivering a corresponding assignment information to be masked with a corresponding ID [a DID, a paging cycle, a newly defined identifier (e.g., temporary no mobility subscriber identifier (TNMSID))] assigned to the idle state mobile station having no mobility and may be then able to transmit an additional field indicating the usage for the idle state mobile station having no mobility in a manner that the additional field is included in the channel for transmitting the corresponding assignment information. In doing so, the paging cycle and the paging cycle may be added as a field into the channel for transmitting the corresponding assignment information instead of masking the CRC.

On the other hand, if the uplink region is assigned to a general mobile station except the idle state mobile station having no mobility, the base station enables the CRC of the channel for transmitting the corresponding assignment information to be masked with an ID (e.g., STID, RNTI, etc.) assigned to the corresponding mobile station and may be then able to transmit the corresponding field of the channel for transmitting the assignment information in a manner of setting the corresponding field to a value indicating that the uplink region is assigned for the usage of the general mobile station.

The base station transmits the information on the uplink region 520/530 assigned to the idle state mobile station having no mobility in a manner that the information is included in the channel (e.g., a DL-MAP in IEEE 802.16e system, a user-specific A-MAP 510 in IEEE 802.16m system, a physical downlink control channel (PDCCH) in 3GPP, etc.) for actually delivering the assignment information of the mobile station. For instance, the base station may be able to inform the mobile stations of the information on the uplink region 520/530 only for the idle state mobile stations having no mobility via the user specific A-MAP of the specific subframe 510. Meanwhile, the base station may be able to assign the uplink region 540 to a general mobile station except the idle state mobile station having no mobility via the user specific A-MAP 510 as well. In doing so, the uplink region 520/530 only for the idle state mobile stations having no mobility and the uplink region 540 for the general mobile station except the idle state mobile station having no mobility may be assigned in the frequency division multiplexed form shown in FIG. 5 for example.

In the following description, a method for an idle state mobile station having no mobility to transmit an uplink data in IEEE 802.16m system according to another embodiment of the present invention is explained. First of all, Table 2 is provided to describe a CRC mask in IEEE 802.16m system.

TABLE 2

| Masking Prefix (1 bit MSB) | Remaining 15 bit LSBs | |
|---|---|---|
| | Type Indicator | Masking Code |
| 0b0 | 0b000 | 12 bit STID or TSTID |
| | 0b001 | Refer to Table 844 |
| | 0b010 | Refer to Table 845 |

| | |
|---|---|
| 0b1 | 15 bit RA-ID: The RA-ID is derived from |
| | the AMS′ random access attributes |
| | (i.e., superframe number (LSB 5 bits), |
| | frame_index (2 bits), preamble code index |
| | for ranging or BR (6 bits) and opportunity |
| | index for ranging or BR (2 bits)) as |
| | defined below: |
| | RA-ID = (LSB 5 bits of superframe |
| | number\|frame_index\| |
| | preamble_code_index\|opportunity_index) |

Referring to Table 2, a masking prefix is 1-bit long and indicates ‘0’ or ‘1’. If the masking prefix is ‘0’, it indicates a masking code in accordance with a type indicator. In this case, as shown in Table 2, the type indicator is only defined up to ‘000’, ‘001’, and ‘010’. If the type indicator is ‘000’, it indicates an STID or a TSTID of 12-bit long. And, if the type indicator is ‘001’ in Table 2, it is written to refer to Table 844. If the type indicator is ‘010’, it is written to refer to Table 845. Table 844 and Table 845 are represented as Table 3 and Table 4, respectively.

TABLE 3

| Decimal Value | Description |
|---|---|
| 0 | Used to mask Broadcast Assignment A-MAP IE for |
| | broadcast or ranging channel assignment |
| 1 | Used to mask BR-ACK A-MAP IE |
| 2-128 | Used to mask Group Resource Allocation A-MAP IE |
| | (group ID) |
| Others | Reserved |

TABLE 4

| Decimal Value | Description |
|---|---|
| 4095 | Used to mask Broadcast Assignment A-MAP IE for |
| | multicast assignment |
| Others | Reserved |

Table 3 and Table 4 are tables to explain the masking code for ‘001’ and the masking code for ‘010’, respectively.

According to the present embodiment, a base station may be able to inform mobile stations of whether a specific uplink region is assigned to an idle state mobile station having no mobility or other general mobile stations using a masking prefix in a CRC and a 3-bit type indicator. For instance, in this case, the 3-bit type indicator may be defined as ‘011’, which has never been defined until now. Then, the base station may be able to indicate that the specific uplink region is assigned to the idle state mobile station having no mobility in a manner of masking an ID for the idle state mobile station having no mobility with the masking prefix ‘0’ and the 3-bit type indicator ‘011’ value.

Yet, if the total bit number of the identification fields is greater than the CRC, the remaining unmasked identification field, which is not being masked, (e.g., x bit(s) of DID, a paging cycle, and a newly defined identifier TNMSID y bit) may be added as a field in a channel (e.g., user specific A-MAP, PDCCH) for actually delivering an assignment information of a mobile station.

In the following description, a method for an idle state mobile station having no mobility to perform a network reentry procedure in IEEE 802.16m system according to another embodiment of the present invention is explained with reference to the accompanying drawing.

First of all, when a data transmission/reception (interaction) is necessary between an idle state mobile station having no mobility and a base station, the base station may be able to transmit an uplink assignment information in a manner of having the information included in a listening interval of the idle state mobile station having no mobility. And, the base station may be able to make a request for the idle state mobile station having no mobility to enter an active state. In particular, the base station may be able to allocate a necessary uplink resource in order for the idle state mobile station having no mobility to perform an active state entering procedure (i.e., a network reentry procedure for exchanging a ranging request message, a registration request message, a basic capability negotiation request (basic capability request) message, a dynamic service, and the like in IEEE 802.16m system, a network reentry procedure for performing a network connection establishment or reestablishment in 3GPP system, etc.).

The base station may be able to transmit the CRC of the assignment information on the uplink resource allocation in a manner that the CRC is masked with a parameter (e.g., DID and paging cycle, a newly defined identifier TNMSID, etc.). The base station may be then able to inform a corresponding idle state mobile station having no mobility that the resource allocation is performed for a prescribed mobile station. In particular, the corresponding idle state mobile station having no mobility may be aware whether the uplink region information assigned to the mobile station is transmitted from the base station based on the parameter (e.g., DID and paging cycle or a newly defined identifier TNMSID), which is assigned for the purpose of discriminating (or identifying) the corresponding idle state mobile station having no mobility. The idle state mobile station have no mobility may perform the network reentry procedure via an uplink region, which is identified as assigned to the idle state mobile station having no mobility.

In this case, the CRC of the assignment information on the uplink resource allocation may be masked with one group ID to which the idle state mobile stations having no mobility i belong.

The processor 180 of the base station may enable the CRC of the assignment information on the uplink resource allocation to be masked with a single paging cycle value. As mentioned in the foregoing description, the base station enables the uplink assignment information for the idle state mobile station having no mobility to be CRC-masked with one of the reserved values of the paging cycle and may be then able to transmit the uplink assignment information to one group to which the idle state mobile stations having no mobility belong. Table 5 shows the values used to indicate a paging cycle for a mobile station.

TABLE 5
Used to indicate Paging cycle for the AMS

| | |
|---|---|
| 0x00: | 4 superframes |
| 0x01: | 8 superframes |
| 0x02: | 16 superframes |
| 0x03: | 32 superframes |
| 0x04: | 64 superframes |
| 0x05: | 128 superframes |
| 0x06: | 256 superframes |
| 0x07: | 512 superframes |
| 0x08-0x15: | reserved |

Referring to Table 5, the reserved value of a paging cycle ranges from 0X08 to 0X15. The base station may be able to select one value among the range of 0X08˜0X15 for the usage of a group ID to which the mobile stations having no mobility in idle state belong. The processor 180 of the base station enables the CRC of the uplink resource assignment information for the idle state mobile station having no mobility to be masked with the selected value or may be able to include the CRC in the assignment information. As a different example, the base station may be able to assign a TNMSID, which is a newly defined identifier for the purpose of grouping. In particular, the base station may be able to transmit the uplink assignment information in a manner that the CRC is masked with the TNMSID, which is selected for the purpose of group ID to which the idle state mobile stations having no mobility belong.

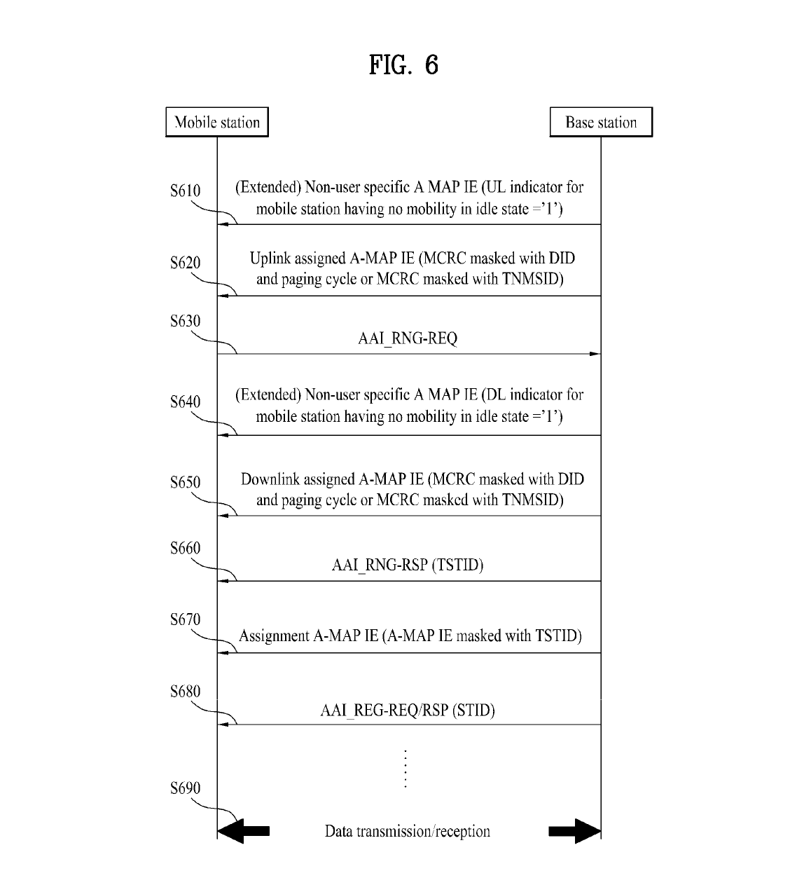

FIG. 6 is a flowchart to describe an operation of an idle state mobile station having no mobility according to one embodiment of the present invention described in FIG. 4.

A mobile station having no mobility in idle state may be able to receive an uplink indicator transmitted via a non-user specific A MAP IE or an extended non-user specific A MAP IE in a listening interval of the mobile station [S610]. In doing so, the transmitted uplink identifier may be able to indicate whether the user specific A-MAP IE transmitted in a subframe corresponding to the corresponding A-MAP IE is control information only for the idle state mobile station having no mobility.

If the uplink identifier value transmitted by the base station is ‘1’, the idle state mobile station having no mobility may be able to check by receiving an uplink A-MAP IE (e.g., uplink assignment information, etc.) in a subframe corresponding to the received non-user specific A-MAP IE or an extended non-user specific A-MAP IE [S620]. In doing so, the transmitted uplink assignment A-MAP IE may include an MCRC, which is masked with the DID and the paging cycle, or the MCRC, which is masked with the TNMSID. Since the idle state mobile station having no mobility has an identifier, which is assigned in advance, for the idle state mobile station having no mobility (e.g., DID and paging cycle, or a newly defined TNMSID), the mobile station may be able to check whether the uplink assignment information is CRC-masked with the DID and the paging cycle corresponding to the identifier of the mobile station, or the TNMSID [S620].

Thereafter, if there is an uplink region information assigned to the mobile station having no mobility in idle state, i.e., if the uplink assignment information, which has been CRC-masked with the identifier of its own, is transmitted, the idle state mobile station having no mobility may be able to perform a network reentry procedure via the assigned uplink region. According to FIG. 6, as a network reentry procedure, the idle state mobile station having no mobility sends a ranging request message (AAI-RNG-REQ) to the base station [S630]. The idle state mobile station having no mobility may be then able to receive a non-user specific A-MAP IE or an extended non-user specific A-MAP IE message including a downlink indicator for the idle state mobile station having no mobility from the base station [S640]. In the step S640, the downlink identifier is an identifier indicating whether there is downlink data to be transmitted to the idle state mobile station having no mobility by the base station. For instance, if the downlink identifier is transmitted in a manner of being set to ‘1’, which indicates that there is downlink data to be transmitted to the idle state mobile station having no mobility, the idle state mobile station having no mobility may be then able to figure out that there is downlink data to receive.

The idle state mobile station having no mobility may be then able to receive a downlink assignment A-MAP IE from the base station [S650]. In this case, the downlink assignment A-MAP IE includes an MCRC, which is masked with the DID and the paging cycle, or an MCRC, which is masked with a newly defined identifier TNMSID. And, the downlink assignment A-MAP IE may be able to include information on the downlink region assigned only for the idle state mobile station having no mobility. And, the idle state mobile station having no mobility may be able to receive a ranging response message (e.g., AAI-RNG-RSP) including a TSTID, which is an assigned temporary station ID, from the base station [S660].

The idle state mobile station having no mobility may be then able to receive an assignment A-MAP IE from the base station [S670]. The assignment A-MAP IE includes the MCRC, which is masked with the TSTID.

The idle state mobile station having no mobility may be able to exchange a message (AAI-REG-REQ/RSP) for negotiating a capability and a registration with the base station [S680]. In doing so, the base station may be able to transmit an STID assigned to the idle state mobile station having no mobility via the

As mentioned in the above, if the idle state mobile station having no mobility receives the ranging response message (AAI-RNG-RSP) from the base station, the mobile station may be able to perform the rest of procedures for the network reentry, i.e., exchanging a registration request message, a basic capability request message, and a dynamic service message. Yet, if it is same with the information concluded with the base station in the procedure of initial network entry by the idle state mobile station having no mobility (e.g., a capability negotiation or a security negotiation), the rest of procedures for the network reentry, i.e., the procedure of exchanging the basic capability request message, the dynamic service message and the like may be omitted and the omitted procedure can be set to a conventional information value.

Having completed the network reentry procedure, the idle state mobile station having no mobility may be able to perform a data transmission/reception (interaction) with the base station [S690].

In this case, if the idle state mobile station having no mobility and the base station agree to use the information on the capability and security negotiation and the like as it is concluded in the initial network entry procedure, the idle state mobile station having no mobility may be able to directly transmit uplink data via the uplink region assigned to the idle state mobile station having no mobility in the step S620 without performing the network reentry procedure.

Meanwhile, if the uplink identifier value transmitted by the base station in the step S610 is ‘0’, the idle state mobile station having no mobility may be able to ignore an uplink A-MAP IE (e.g., an uplink assignment information, etc.) in a subframe corresponding to the received non-user specific A-MAP IE or extended non-user specific A-MAP IE.

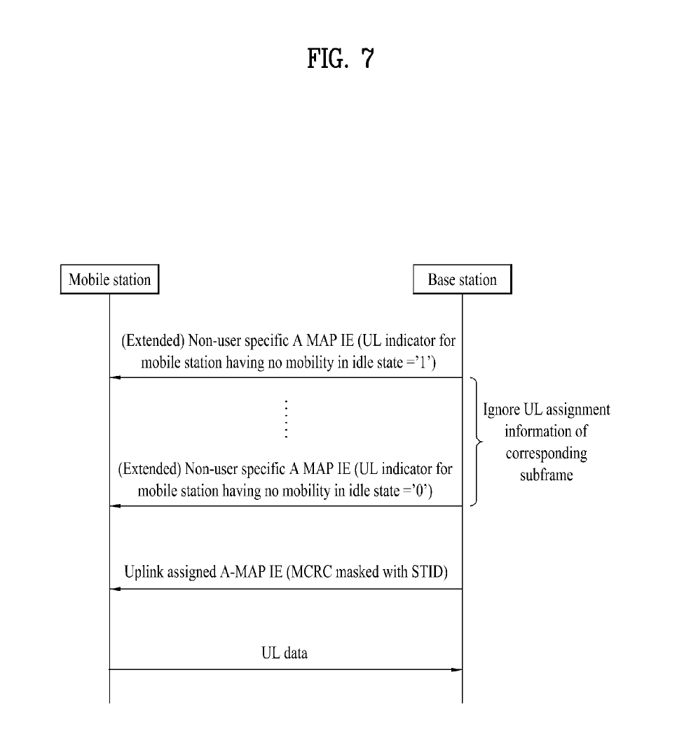

FIG. 7 is a diagram to describe an operation of mobile station (or the rest of mobile stations) other than an idle state mobile station having no mobility in IEEE 802.16m system according to one embodiment of the present invention described with reference to FIG. 4.

The mobile station other than an idle state mobile station having no mobility may include an active state mobile station or an idle state mobile station having mobility. This mobile station is called a general mobile station in the present invention. The active state mobile station i may be able to receive an uplink indicator transmitted via a non-user specific A-MAP IE or (extended) non-user specific A-MAP IE in almost all downlink intervals. The idle state mobile station having mobility may be able to receive the uplink identifier transmitted via the non-user specific A-MAP IE or (extended) non-user specific A-MAP IE in its own listening interval. The uplink identifier may be able to indicate whether there is control information only for the idle state mobile station having no mobility in the user specific A-MAP IE transmitted in a subframe corresponding to a corresponding A-MAP IE. For instance, if the uplink indicator value is ‘1’, it may indicate that there is control information for the idle state mobile station having no mobility. If the uplink indicator value is ‘0’, it may indicate that there is no control information (e.g., an information on the assigned uplink region) for the mobile station having no mobility in idle.

Therefore, if the uplink indicator value transmitted by the base station is ‘1’, since the mobile station except the idle state mobile station having no mobility, i.e., the general mobile station does not have a control information corresponding to its own (e.g., the information on the assigned uplink region), the general mobile station ignores the uplink A-MAP IE (e.g., uplink assignment information) in the subframe corresponding to the non-user specific A-MAP IE or extended non-user specific A-MAP IE. In particular, if the uplink indicator value transmitted by the base station is ‘1’, the general mobile station may not be able to decode the uplink assignment information of the subframe corresponding to the non-user specific A-MAP IE or extended non-user specific A-MAP IE.

On the other hand, if the uplink indicator value transmitted by the base station is ‘0’, the general mobile station may be able to receive the uplink assignment A-MAP IE including the MCRC, which is masked with the STID, from the base station. In doing so, the uplink assignment A-MAP IE may include the information on the uplink region assigned to the general mobile station. The general mobile station may be able to transmit the uplink data to the base station based on the information on the assigned uplink region.

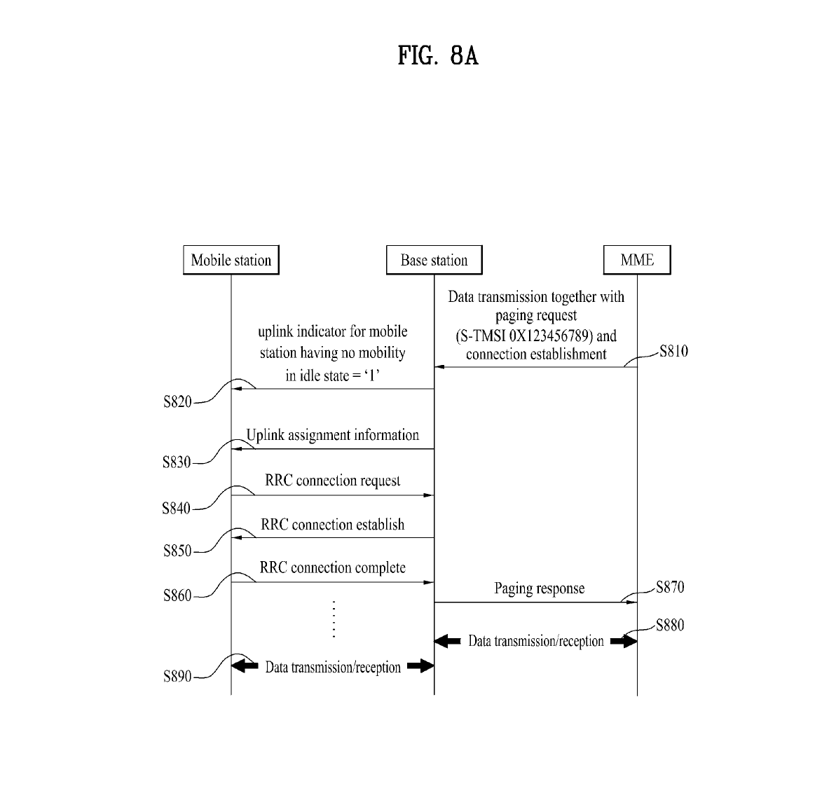

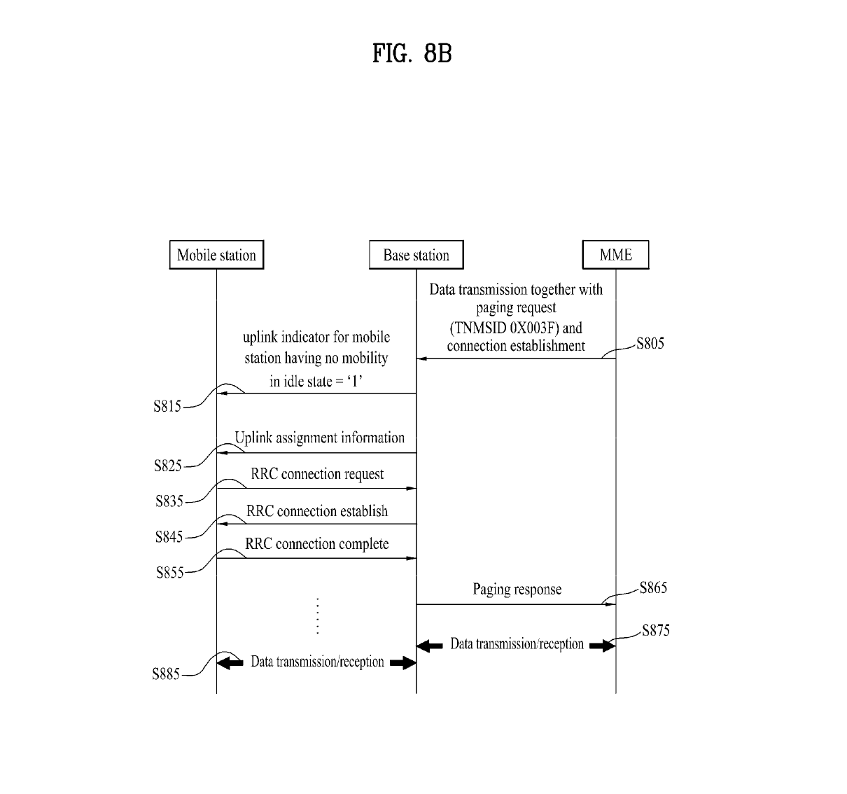

FIG. 8A and FIG. 8B are flowcharts to describe an operation of an idle state mobile station having no mobility according to one embodiment of the present invention.

Referring to FIG. 8A, an MME may be able to send a paging request message to a base station [S810]. In doing so, the paging request message includes an S-TMSI, which is an identifier for the idle state mobile station having no mobility. As an example, the S_TMSID may be 0X123456789F. The paging request message may be able to make a request for a connection establishment/reestablishment of the idle state mobile station having no mobility.

The base station may be then able to transmit PDCCH in a manner of having a CRC masked with 0XFFF5, which is one of the reserved RNTI, for an uplink indicator (e.g., represented as bit value ‘1’) indicating control information for the idle state mobile station having no mobility [S820]. As the idle state mobile station having no mobility receives the PDCCH having the CRC masked with 0XFFF5 from the base station, it may be able to aware that the control information indicating whether the uplink resource for the idle state mobile station having no mobility is assigned has been transmitted. It may be then able to implicitly determine that a slot corresponding to the corresponding PDCCH is assigned to the idle state mobile station having no mobility[S820].

In doing so, if the PDCCH having the CRC masked with 0XFFF5, which is one of the reserved RNTI, is not received, every mobile station may be able to implicitly determine that the slot corresponding to the corresponding PDCCH is assigned to the general mobile station.

The idle state mobile station having no mobility receives the PDCCH having the CRC masked with a TNMSID assigned to its own among the identifiers (e.g., assigned as 0X003F) for the idle state mobile station having no mobility and the PDCCH including the uplink assignment information from the base station [S830].

The idle state mobile station having no mobility sends an RRC connection request message to the base station based on the uplink assignment information received in the step S830 [S840]. The base station may be able to send an RRC connection setup message to the idle state mobile station having no mobility in response to the RRC connection request message [S850]. The idle state mobile station having no mobility may be then able to send an RRC connection completion message to the base station [S860]. The base station may be able to send a paging response message to the MME in response to the paging request transmitted in the step S810 [S870]. The base station and the MME may be then able to perform data transmission/reception [S880] and the base station and the idle state mobile station having no mobility may be able to perform the data transmission/reception as well [S890].

FIG. 8a corresponds to a case that the MME and the base station differently manage the identifier for the idle state mobile station having no mobility from each other. In particular, the MME manages the identifier for the idle state mobile station having no mobility with the S-TMSI and the base station manages the identifier for the idle state mobile station having no mobility with the newly defined identifier TNMSID.

As a different embodiment, referring to FIG. 8B, the MME may be able to send the paging request message to the base station [S805]. In doing so, the paging request message includes a TNMSID, which is an identifier for the idle state mobile station having no mobility. For instance, it may be 0X003F. The paging request message may be able to make a request for a connection establishment/reestablishment of the idle state mobile station having no mobility.

The base station may be then able to transmit the PDCCH having the CRC masked with 0XFFF5, which is one of the reserved RNTI, for an uplink indicator (e.g., represented as bit value ‘1’) indicating control information for the idle state mobile station having no mobility [S815]. As the idle state mobile station having no mobility receives the PDCCH having the CRC masked with 0XFFF5, it may be able to know that the control information indicating whether the uplink resource for the idle state mobile station having no mobility is allocated has been transmitted and it may be able to implicitly determine that a slot corresponding to the corresponding PDCCH is assigned to the idle state mobile station having no mobility. Moreover, as the idle state mobile station having no mobility receives the uplink indicator having a value of ‘1’, it may be able to explicitly determine that a slot corresponding to the corresponding PDCCH is assigned to the idle state mobile station having no mobility.

In doing so, if the PDCCH having the CRC masked with 0XFFF5, which is one of the reserved RNTI, is not received, every mobile station may be able to implicitly determine that the slot corresponding to the corresponding PDCCH is assigned to the general mobile station.

The idle state mobile station having no mobility may be then able to receive the PDCCH having the CRC masked with the TNMSID (e.g., assigned as 0X003F) assigned to its own among the identifiers for the idle state mobile station having no mobility and the PDCCH including the uplink assignment information from the base station [S825]. The idle state mobile station having no mobility sends an RRC connection request message to the base station [S835]. The base station may be able to send an RRC connection setup message to the idle state mobile station having no mobility in response to the RRC connection request message [S845]. The idle state mobile station having no mobility may be then able to send an RRC connection completion message to the base station [S855]. The base station may be able to send a paging response message to the MME in response to the paging request transmitted in the step S805 [S865]. The base station and the MME may be able to perform data transmission/reception [S875] and the base station and the idle state mobile station having no mobility may be able to perform the data transmission/reception as well [S885].

FIG. 8b corresponds to the case that the MME and the base station manage the identifier for the idle state mobile station having no mobility using the same TNMSID.

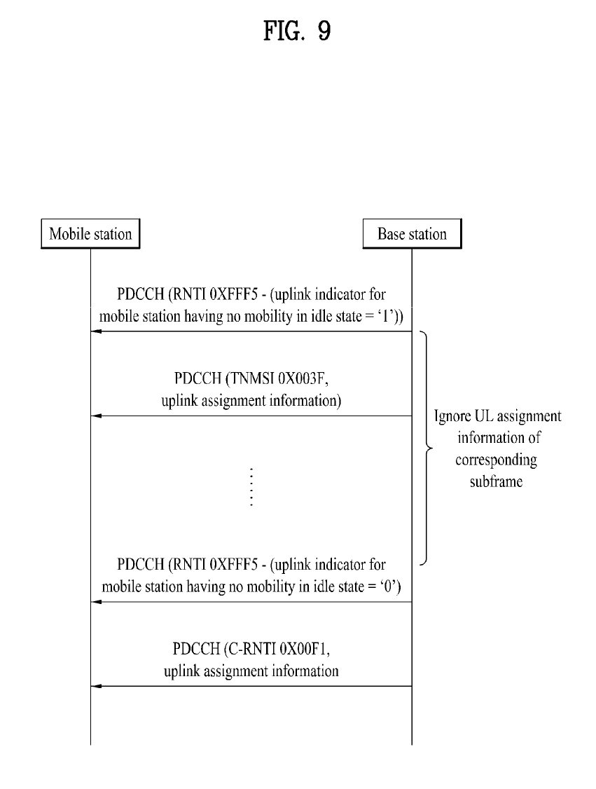

FIG. 9 is a diagram to describe an operation in aspect of mobile station other than an idle state mobile station having no mobility according to another embodiment of the present invention.

Other mobile stations except the idle state mobile stations having no mobility, i.e., general mobile stations may include activate state mobile stations or idle state mobile stations having mobility and the like. The base station may be able to transmit PDCCH in a manner of having the CRC masked with 0XFFF5, which is one of the reserved RNTI, for an uplink indicator (e.g., represented as bit value ‘1’), control information indicating whether the uplink resource for the idle state mobile station having no mobility is allocated. The rest of mobile stations except the idle state mobile station having no mobility may be able to receive the PDCCH including the uplink indicator, which is the control information for the mobile station having no mobility from the base station.

As the general mobile station receives the PDCCH having the CRC masked with 0XFFF5, which is one of the reserved RNTI, it may be able to know that the control information indicating whether the uplink resource for the idle state mobile station having no mobility is allocated has been transmitted and it may be able to implicitly determine that a slot corresponding to the corresponding PDCCH is assigned to the idle state mobile station having no mobility. In particular, as the general mobile station receives the uplink indicator having a value of ‘1’, it may be able to explicitly determine that the slot corresponding to the corresponding PDCCH is assigned to the idle state mobile station having no mobility.

In doing so, if the PDCCH having the CRC masked with 0XFFF5, which is one of the reserved RNTI, is not received, every mobile station may be able to implicitly determine that the slot corresponding to the corresponding PDCCH is assigned to the general mobile station.

Subsequently, the rest of the mobile stations except the idle state mobile station having no mobility, i.e., the general mobile station may be then able to ignore the uplink assignment information of the corresponding slot of the corresponding subframe indicated by the PDCCH. The general mobile station may be then able to receive the PDCCH having the CRC masked with 0XFFF5, which is one of the reserved RNTI for an uplink indicator (e.g., represented as bit value ‘0’) indicating control information for the rest of the mobile station except the idle state mobile station having no mobility. The general mobile station may be then able to receive the PDCCH including the uplink assignment information for the general mobile station. In this case, the PDCCH including the uplink assignment information may be transmitted in a manner of having the CRC masked with a C-RNTI (e.g., 0X00F1).

According to the aforementioned various embodiments of the present invention, it enabled the idle state mobile stations having no mobility to perform a fast and efficient network reentry, whereby communication performance is considerably enhanced.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, a method of reentering a network of an idle state mobile station having no mobility and a method of supporting the same are industrially available for various wireless communication systems including 3GPP LTE/LTE-A, IEEE 802 and the like.

1. A method of supporting a network reentry of an idle stat mobile station having no mobility by a base station in a wireless communication system, comprising:
transmitting first information including information indicating whether there is an uplink region assigned only for the idle stat mobile station having no mobility to the idle stat mobile station having no mobility.

2. The method of claim 1, further comprising:
transmitting second information including the information on the assigned uplink region to the idle state mobile station having no mobility, wherein the first information comprises at least a superframe header (SFH), a broadcast control channel (BCCH), a non-user specific A-MAP IE, an extended non-user specific A-MAP IE, or a physical downlink control channel (PDCCH).

3. The method of claim 2, wherein the information on the assigned uplink region is indicated by a superframe index, a frame index, a subframe index or a slot index.

4. The method of claim 1, wherein the first information further comprises the information on the assigned uplink region.

5. The method of claim 4, wherein the information on the assigned uplink region is transmitted in a manner of being masked with an identifier for the idle state mobile station having no mobility.

6. The method of claim 4, wherein the first information comprises at least a user specific A-MAP IE, an extended user specific A-MAP IE or a physical downlink control channel (PDCCH).

7. The method of claim 1, further comprising:
receiving a ranging request message from the idle state mobile station having no mobility via the assigned uplink region.

8. The method of claim 7, further comprising:
transmitting third information including a downlink identifier indicating whether there is a downlink region assigned for the idle state mobile station having no mobility; and
transmitting fourth information including the information on the downlink region masked with the identifier for the idle state mobile station having no mobility.

9. The method of claim 8, further comprising:
sending a ranging response message in response to the ranging request message.

10. A method of performing a network reentry of an idle state mobile station having no mobility in a wireless communication system, comprising:
receiving, first information including information indicating whether there is an assigned uplink region only for the idle state mobile station having no mobility, from a base station.

11. The method of claim 10, further comprising:
receiving second information including the information on the assigned uplink region, from the base station.

12. The method of claim 10, wherein the first information further comprises the information on the assigned uplink region.

13. The method of claim 12, wherein the information on the assigned uplink region is transmitted in a manner of being masked with an identifier for the idle state mobile station having no mobility.

14. The method of claim 10, further comprising:
sending a ranging request message to the base station via the assigned uplink region.

15. The method of claim 14, further comprising:
receiving, third information that contains a downlink identifier indicating whether there is a downlink region assigned for the idle state mobile station having no mobility, from the base station; and
receiving, fourth information including the information on the downlink region masked with an identifier for the idle state mobile station having no mobility, from the base station.

16. The method of claim 15, further comprising:
receiving a ranging response message from the base station.

17. A base station apparatus of supporting a network reentry of an idle state mobile station having no mobility in a wireless communication system, comprising
a transmitter configured to transmit first information including information indicating whether there is an uplink region assigned only for the idle state mobile station having no mobility to the idle state mobile station having no mobility.

18. The base station apparatus of claim 17, wherein the first information further comprises the information on the assigned uplink region.

19. A mobile station apparatus performing a network reentry in a wireless communication system, comprising
a receiver configured to receive first information including information indicating whether there is an uplink region assigned only for the idle state mobile station having no mobility from a base station.

20. The mobile station apparatus of claim 19, wherein the first information further comprises the information on the assigned uplink region and wherein the information on the assigned uplink region is transmitted in a manner of being masked with an identifier for the idle state mobile station having no mobility.
